(19) United States
(12) Patent Application Publication
(10) Pub. No.: US 2014/0343771 A1
(43) Pub. Date: Nov. 20, 2014

(54) SYSTEM AND METHOD OF CONVERTING DRIVING MODE AND CONTROLLING SHIFTING OF HYBRID VEHICLE

(71) Applicant: Hyundai Motor Company, Seoul (KR)

(72) Inventor: Sang Joon Kim, Seoul (KR)

(73) Assignee: HYUNDAI MOTOR COMPANY, Seoul (KR)

(21) Appl. No.: 14/044,018

(22) Filed: Oct. 2, 2013

(30) Foreign Application Priority Data
May 14, 2013 (KR) 10-2013-0054194

(51) Int. Cl. B60W 20/00; B60W 10/10; B60W 10/06; B60W 10/02

(52) U.S. Cl. CPC B60W 20/40; B60W 10/02; B60W 10/10; B60W 10/06; Y10S 903/93
USPC 701/22; 180/65.265; 903/930

(57) ABSTRACT

A system and method of converting a driving mode and controlling shifting of a hybrid vehicle are provided. The method includes simultaneously converting, by a controller, a driving mode and controlling shifting of a hybrid vehicle when a high torque is required according to the an acceleration requirement of a driver when the hybrid vehicle is driven in an EV mode. Therefore, an acceleration response for the acceleration requirement of the drive may be improved.

### CROSS-REFERENCE TO RELATED APPLICATION

This application claims under 35 U.S.C. §119(a) the benefit of Korean Patent Application No. 10-2013-0054194, filed on May 14, 2013, the entire contents of which are incorporated herein by reference.

### BACKGROUND

(a) Technical Field

The present invention relates to a system and method of converting a driving mode and controlling shifting of a hybrid vehicle, and more particularly, to a method of converting a driving mode and controlling shifting of a hybrid vehicle, by which an acceleration response may be improved as a driving mode of a hybrid vehicle is converted from an electric vehicle (EV) mode into a hybrid electric vehicle (HEV) mode and a gearshift is controlled at the same time.

(b) Background Art

A hybrid vehicle may have various power transmission structures using two or more power sources including an engine and a motor, and most of current hybrid vehicles adopt one of parallel and serial power transmission configurations.

As shown in FIG. 1, in a power train for parallel hybrid vehicles, an engine 10, an Integrated Starter/Generator 20 (ISG), a wet multi-plate type engine clutch 30, a motor 40, and a transmission 50 are sequentially arranged on one axis thereof, and a battery 60 is connected to the motor 40 and the ISG 20 via a inverter to be recharged and discharged.

In the hybrid vehicle using an engine and an motor, the motor 40 is driven when the vehicle is initially started, and a generator, that is, the ISG 20 starts the engine and the engine clutch 30 is simultaneously engaged to drive the vehicle using both an output of the engine and an output of the motor when a speed of the vehicle is a predetermined speed or higher. Thus, rotary power of the engine 10 is shifted via a planetary gear unit of the transmission 50 and is transferred to driving wheels 70 of the vehicle.

Driving modes of the hybrid electric vehicle transferring the power using the above configuration are classified into an EV mode and a HEV mode.

The EV mode is a driving mode in which the vehicle is driven only by a driving force of the motor 40 while the engine clutch 30 between the engine 10 and the motor 40 is unengaged. The HEV mode is a driving mode in which power of the engine and power of the motor are transferred to a driving shaft together while the engine clutch 30 is engaged, and then the HEV mode corresponds to a driving state in which engine power can be used as a main driving force or generation power using the motor. In this way, the hybrid vehicle is driven through frequent transitions of driving modes to an EV mode or to a HEV mode via engagement of the engine clutch according to a torque required by a driver.

Moreover, the transmission is continuously shifted when the driving mode of the hybrid vehicle is converted from the EV mode into the HEV mode, and conversion of the driving mode and control of shifting of the hybrid vehicle are separately performed in the related art. In other words, as a method of separately progressing the conversion of the driving mode and the control of the shifting of the hybrid vehicle according to the related art, conversion of a driving mode from the EV mode into the HEV mode and control of shifting of the hybrid vehicle are prioritized, or shifting of the hybrid vehicle is controlled after the driving mode is converted from EV mode into HEV mode first.

The acceleration response for an acceleration requirement of a driver is lowered as converting of the driving mode and control of shifting of the hybrid vehicle are separately performed. In particular, when the acceleration requirement such as a kick down, in which a driver rapidly engages an accelerator pedal, is performed during the EV mode in which the vehicle is driven only by a motor driving force (Wm), a mode conversion control by which the driving mode is converted to the HEV mode while the engine is started and the engine clutch is engaged, and a shifting control by which a shifting down control according to the kick down of the transmission is performed are separately progressed. Accordingly, as shown in FIG. 1, a delay time section between a time point when the mode conversion is completed and a time point when the control of the shifting of the hybrid vehicle is completed is generated.

A time interval between the mode conversion completing time point and the shifting control completing time point is generated as the conversion of the driving mode from the EV mode into the HEV mode and the control of the shifting of the hybrid vehicle are separately performed, generating a time delay until the required acceleration actually required by a driver is satisfied.

### SUMMARY

The present invention provides a system and method of converting a driving mode and controlling shifting of a hybrid vehicle by which conversion of the driving mode from EV mode into HEV mode and control of shifting of the hybrid vehicle are promptly performed simultaneously when a high torque is required according to the an acceleration requirement of a driver when the hybrid vehicle is driven in an EV mode to improve an acceleration response for the acceleration requirement of the drive.

In accordance with an aspect of the present invention, a method of converting a driving mode and controlling shifting of a hybrid vehicle is provided, including: simultaneously performing a driving mode conversion control from an EV mode into a HEV mode, using an engine clutch pressure control, and a shifting control process using a transmission pressure control are performed when an acceleration requirement is generated by a user when a hybrid vehicle is driven in EV mode to minimize a delay time interval between a time point when the mode conversion is completed and a time point when the control of shifting of the hybrid vehicle is completed. The acceleration requirement may be a kick down state.

The shifting control process using the transmission pressure control may include: controlling a pressure for a released clutch element to be synchronized with an applied clutch element through a slip of the released clutch element of a transmission when a gear is shifted to a target gear in a state such as the kick down; and releasing a pressure control for the released clutch element and increasing a pressure for the applied clutch element when a motor speed is synchronized with a target speed for coupling the applied clutch element of the target gear.

The engine clutch pressure control process may include: starting an engine using the engine clutch pressure control; and applying an engine clutch pressure maximally to completely convert the driving mode from an EV mode into a HEV mode when an engine speed according to the engine start and the motor speed are synchronized with each other.

The engine may be started by applying a pressure (e.g., oil pressure) to the engine clutch, which may be greater than an engine static friction force; and applying a torque greater than the engine static friction force to the engine clutch Further, control of a motor torque to be: [the motor required torque+the engine clutch torque (load)], when the engine is started may be further performed during the driving mode conversion control and the transmission pressure control. In addition, during the driving mode conversion control and the transmission pressure control, an engine torque may be output by an effective torque before the mode conversion is completed and the engine torque may be output by an engine required torque after the mode conversion is completed.

After the motor speed and the target speed are synchronized with each other, the applied clutch element of the target gear may be synchronized by releasing the pressure control for the released clutch element and increasing the pressure for the applied clutch element to completely shift the gear to the target gear according to the driver acceleration requirement.

The present invention provides the following effects.

According to the present invention, conversion of the driving mode from an EV mode into a HEV mode and control of shifting of the hybrid vehicle may be performed simultaneously when a high torque is required according to an acceleration requirement (e.g., kick down) of a driver when the hybrid vehicle is driven in an EV mode to reduce a delay time interval between a time point when conversion of the mode is completed and a time point when control of shifting of the hybrid vehicle is completed. Accordingly, an acceleration response satisfying an acceleration requirement of a driver may be improved.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 is an exemplary diagram showing a power transmission system of a hybrid vehicle according to the related art;

FIG. 2 is an exemplary control diagram showing a process of converting a driving mode of a hybrid vehicle from an EV mode to a HEV mode according to the related art;

FIG. 3 is an exemplary control diagram showing a method of converting a driving mode and controlling shifting of a hybrid vehicle according to an exemplary embodiment of the present invention;

FIG. 4 is an exemplary control diagram showing a method of converting a driving mode and controlling shifting of a hybrid vehicle according to an exemplary embodiment of the present invention; and

FIG. 5 is an exemplary flowchart showing a method of converting a driving mode and controlling shifting of a hybrid vehicle according to an exemplary embodiment of the present invention.

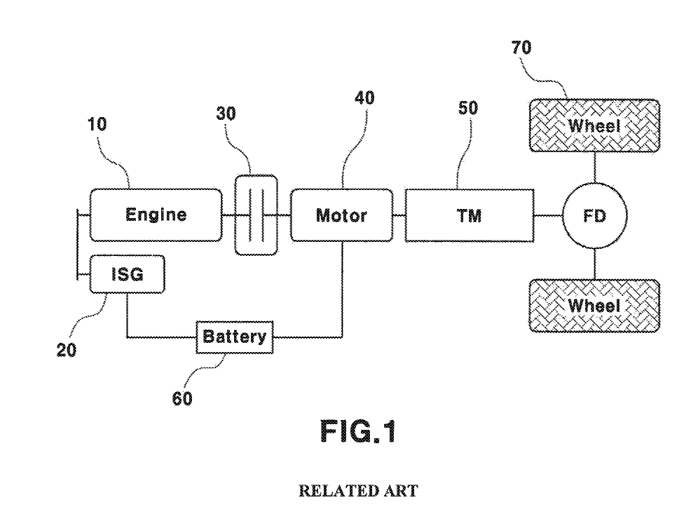

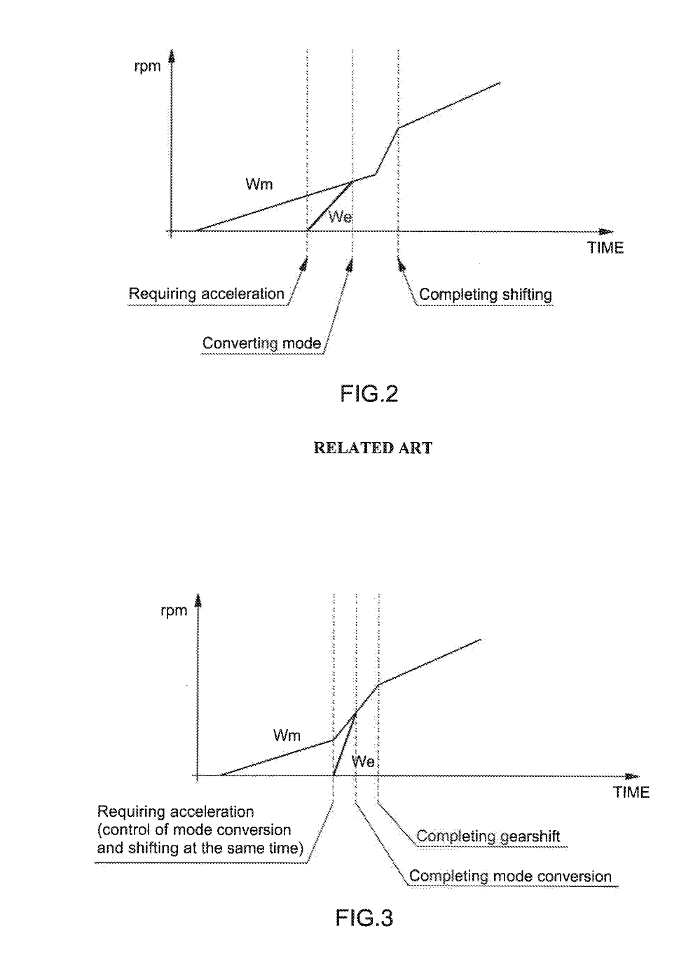

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, fuel cell vehicles, and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, an exemplary embodiment of the present invention will be described in detail with reference to the accompanying drawings.

In the present invention, a driving mode from an EV mode to a HEV mode and control of shifting of a hybrid vehicle may be performed simultaneously by a controller when a high torque is required according to an acceleration requirement of a driver when the hybrid vehicle is driven in an EV mode to reduce a delay time interval between a time point when conversion of the mode is completed and a time point when control of shifting of the hybrid vehicle is completed and an acceleration requirement actually required by a driver may be satisfied. In particular, when an acceleration requirement such as a kick down occurs, control of shifting of the hybrid vehicle via a transmission pressure control and control of conversion of a mode via an engine clutch pressure control may be performed simultaneously.

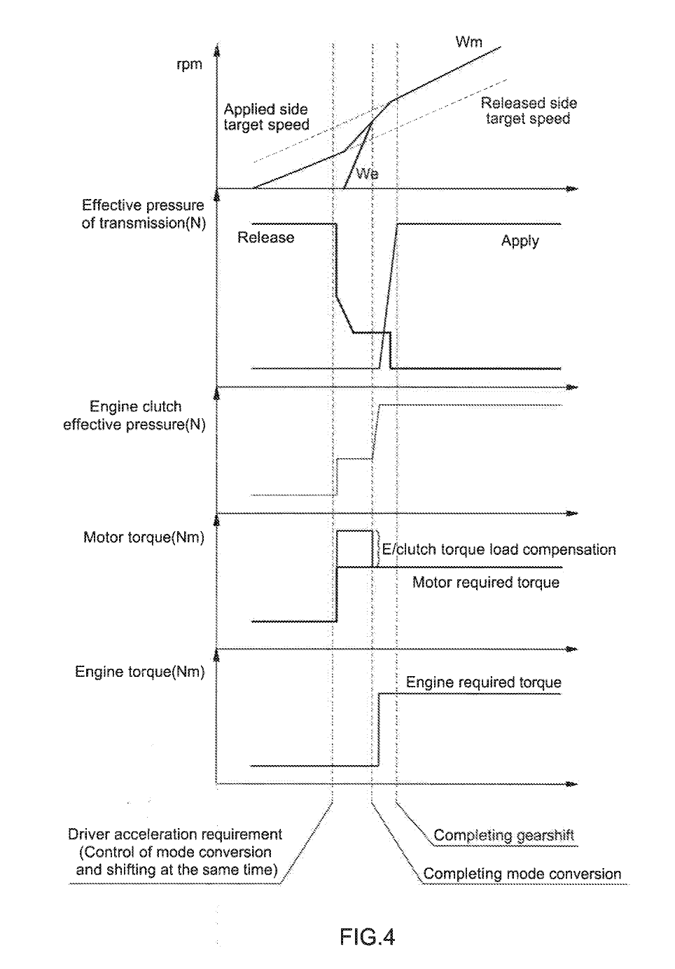

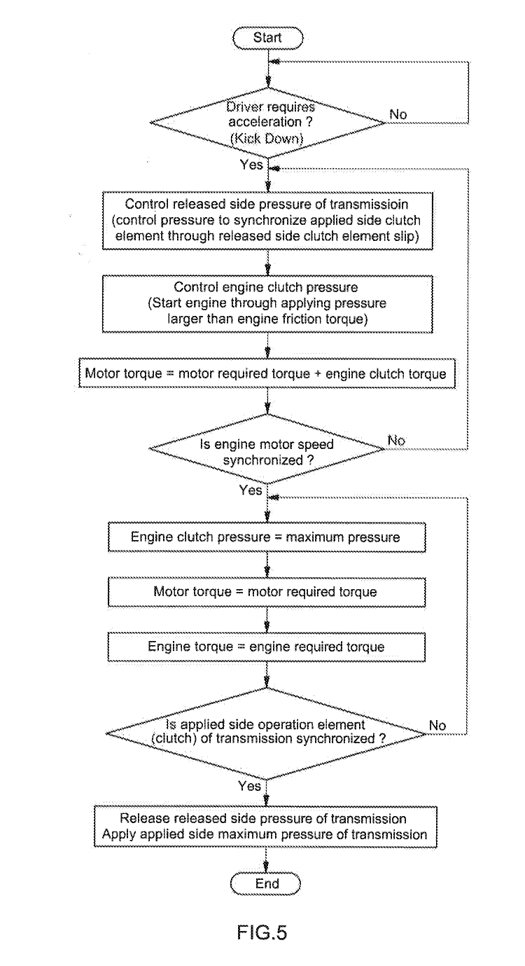

FIGS. 3 and 4 are exemplary control diagrams showing a method of converting a driving mode and controlling shifting of a hybrid vehicle according to the present invention, and FIG. 5 is an exemplary flowchart thereof. First, a transmission control process performed through the transmission pressure control will be described below.

A current gear may be shifted to a lower gear when an acceleration requirement such as the kick down occurs when a hybrid vehicle is driven in an EV mode. When the current gear is shifted to a target gear during a kick down, a released clutch element released from a previous gear operation state and an applied clutch element converted from an operation releasing state into a target gear operation state exist in the transmission, and a pressure control for releasing and applying the released clutch element and the applied clutch element may be performed by controlling oil pressures supplied to the elements.

Then, when the current gear is being shifted to the target gear (e.g., a lower gear) during the kick down, a pressure control for the released clutch element the operation of which is released may be performed. In other words, when the current gear is being shifted to the target gear (e.g., a lower gear) during the kick down, a slip of the released clutch element of the transmission may be generated, and the pressure control for the released clutch element may be performed such that the applied clutch is promptly synchronized through the released clutch slip.

Further, when a motor speed Wm increases to a target speed for coupling the applied clutch element of the target gear, the pressure control for the released clutch element may be released and a pressure for the applied clutch element may be increased to synchronize the applied clutch element and the current gear may be completely shifted to the target gear during the kick down.

A pressure control process of the engine clutch will be described below.

In general, the engine may be started by the ISG function as a generator when the driving mode of a hybrid vehicle is converted from an EV mode into a HEV mode. However, the engine may be started via the engine clutch pressure control to improve a response for the driver acceleration requirement in the present invention. In other words, when the motor is driven in an EV mode, a pressure (e.g., oil pressure) of the engine clutch, which may be greater than an engine static friction force, may be applied and a torque greater than the engine static friction force may be applied to the engine clutch to start the engine in a stop state.

The engine clutch pressure may be maximally applied when an engine speed We according to the engine starting is synchronized with the motor speed Wm to completely convert the driving mode of the vehicle from an EV mode into a HEV mode. Then, the motor speed (rpm) may he reduced when the transmission shifts gears due to an engine clutch torque (e.g., load) generated during start of the engine. Accordingly, the engine clutch torque may be compensated for a motor required torque. Thus, a process of controlling a motor torque may be performed simultaneously during conversion of the mode and control of shifting of the hybrid vehicle, and the motor torque to be may be controlled to be as follows: [the motor required torque+the engine clutch torque (load)]. For reference, the engine clutch torque may be expressed by [friction efficiency×effective radius×effective pressure×sgn(We−Wm)].

Moreover, an engine torque may be controlled when the engine is started during conversion of the mode and control of shifting of the hybrid vehicle. In other words, an output may be achieved by an effective torque before conversion of the mode is completed when the engine is started, and an output may be achieved by an engine required torque after conversion of the mode is completed.

Then, the output may be performed by the effective torque before conversion of the mode is completed when the engine is started and the output may be performed by the engine required torque after conversion of the mode is completed to prevent a shock from being generated when the engine clutch is completely engaged when the output is performed by the engine required torque when the engine is started, thus, the output may be achieved by the effective torque to prevent the shock before the engine clutch is completely engaged.

Further, after the motor speed Wm according to a motor torque control is synchronized with the engine speed We according to the engine start, the engine clutch pressure may be maximally applied, the motor torque may be applied only to the determined motor required torque, and the engine torque may also be applied to the determined engine required torque. Additionally, after the motor speed Wm according to a motor torque control is synchronized with the engine speed We according to the engine start, the applied clutch element of the target gear may be synchronized by releasing the pressure control for the released clutch element and increasing the pressure for the applied clutch element to completely shift the gear to the target gear according to the acceleration requirement such as the kick down.

According to the above-described present invention, conversion of the driving mode from EV mode into HEV mode and control of shifting of the hybrid vehicle may be performed simultaneously by a controller when the high torque is required according to the driver acceleration requirement (e.g., kick down) when the hybrid vehicle is driven in an EV mode to reduce a delay time interval between a time point when conversion of the mode is completed and a time point when control of shifting of the hybrid vehicle is completed. Accordingly, an acceleration response satisfying an acceleration requirement by a driver may be improved.

What is claimed is:

1. A method of converting a driving mode and controlling shifting of a vehicle, comprising:
simultaneously performing, by a controller, a driving mode conversion control from an Electric Vehicle (EV) mode into a Hybrid Electric Vehicle (HEV) mode using an engine clutch pressure control, and a shifting control process using a transmission pressure control when an acceleration requirement is generated when the vehicle is driven in the EV mode to reduce a delay time interval between a time point when the mode conversion is completed and a time point when the control of shifting of the hybrid vehicle is completed.

2. The method of claim 1, wherein the acceleration requirement is a kick down state.

3. The method of claim 1, wherein the shifting control process using the transmission pressure control includes:
maintaining, by the controller, a pressure for a released clutch element to be synchronized with a pressure for an applied clutch element via a slip of the released clutch element of a transmission when a gear is shifted to a target gear in the kick down state; and
releasing, by the controller, the pressure control for the released clutch element and increasing, by the controller, the pressure for the applied clutch element when a motor speed is synchronized with a target speed for coupling the applied clutch element of the target gear.

4. The method of claim 1, wherein the engine clutch pressure control process includes:
starting, by the controller, an engine via the engine clutch pressure control; and
applying, by the controller, an engine clutch pressure maximally to completely convert the driving mode from an EV mode into a HEV mode when an engine speed according to the engine start and the motor speed are synchronized with each other.

5. The method of claim 4, wherein the engine starting process includes:
applying, by the controller, oil pressure for the engine clutch, which is greater than an engine static friction force; and
applying, by the controller, a torque greater than the engine static friction force to the engine clutch.

6. The method of claim 1, wherein the motor torque is controlled to be:
[the motor required torque+the engine clutch torque (load)]
when the engine is started during the driving mode conversion control and the transmission pressure control.

7. The method of claim 1, further comprising:
maintaining, by the controller, an engine torque to be output by an effective torque before the mode conversion is completed; and
maintaining, by the controller, the engine torque to be output by an engine required torque after the mode conversion.

8. The method of claim 3, further comprising:
releasing, by the controller, the pressure control for the released clutch element and increasing, by the controller, the pressure for the applied clutch element after the motor speed and the target speed are synchronized with each other and the applied clutch element of the target gear is synchronized to shift the gear to the target gear according to the driver acceleration requirement.

9. A system of converting a driving mode and controlling shifting of a vehicle, comprising:
a controller includes a memory and a processor, the memory configured to store program instructions and the processor configured to execute the program instructions, the program instructions when executed configured to:
simultaneously perform a driving mode conversion control from an Electric Vehicle (EV) mode into a Hybrid Electric Vehicle (HEV) mode using an engine clutch pressure control, and a shifting control process using a transmission pressure control when an acceleration requirement is generated when the vehicle is driven in the EV mode to reduce a delay time interval between a time point when the mode conversion is completed and a time point when the control of shifting of the hybrid vehicle is completed.

10. The system of claim 9, wherein the acceleration requirement is a kick down state.

11. The system of claim 9, wherein in the shifting control process using the transmission pressure control, the controller is further configured to:
maintain a pressure for a released clutch element to be synchronized with a pressure for an applied clutch element via a slip of the released clutch element of a transmission when a gear is shifted to a target gear in the kick down state; and
release the pressure control for the released clutch element and increasing, by the controller, the pressure for the applied clutch element when a motor speed is synchronized with a target speed for coupling the applied clutch element of the target gear.

12. The system of claim 9, wherein in the engine clutch pressure control process, the controller is further configured to:
start an engine via the engine clutch pressure control; and
apply an engine clutch pressure maximally to completely convert the driving mode from an EV mode into a HEV mode when an engine speed according to the engine start and the motor speed are synchronized with each other.

13. The system of claim 12, wherein the controller is configured to start the engine by:
applying oil pressure for the engine clutch, which is greater than an engine static friction force; and
applying a torque greater than the engine static friction force to the engine clutch.

14. The system of claim 9, wherein the motor torque is controlled to be:
[the motor required torque+the engine clutch torque (load)]
when the engine is started during the driving mode conversion control and the transmission pressure control.

15. A vehicle operable in at least an HEV (Hybrid Electric Vehicle) mode and an EV (Electric Vehicle) mode, comprising:
a motor configured to supply power to a transmission in at least an EV mode and an HEV mode;
an engine configured to supply power to the transmission in an HEV mode; and
a controller configured to:
simultaneously perform a driving mode conversion control from an EV mode into a HEV mode using an engine clutch pressure control, and a shifting control process using a transmission pressure control when an acceleration requirement is generated when the vehicle is driven in the EV mode to reduce a delay time interval between a time point when the mode conversion is completed and a time point when the control of shifting of the hybrid vehicle is completed.

16. The vehicle of claim 15, wherein the acceleration requirement is a kick down state.

17. The vehicle of claim 15, wherein in the shifting control process using the transmission pressure control, the controller is further configured to:
maintain a pressure for a released clutch element to be synchronized with a pressure for an applied clutch element via a slip of the released clutch element of a transmission when a gear is shifted to a target gear in the kick down state; and
release the pressure control for the released clutch element and increasing, by the controller, the pressure for the applied clutch element when a motor speed is synchronized with a target speed for coupling the applied clutch element of the target gear.

18. The vehicle of claim 15, wherein in the engine clutch pressure control process, the controller is further configured to:
start an engine via the engine clutch pressure control; and
apply an engine clutch pressure maximally to completely convert the driving mode from an EV mode into a HEV mode when an engine speed according to the engine start and the motor speed are synchronized with each other.

19. The vehicle of claim 15, wherein the controller is configured to start the engine by:
applying oil pressure for the engine clutch, which is greater than an engine static friction force; and
applying a torque greater than the engine static friction force to the engine clutch.

20. The vehicle of claim 15, wherein the motor torque is controlled to be:
[the motor required torque+the engine clutch torque (load)]
when the engine is started during the driving mode conversion control and the transmission pressure control.
